(19) United States
(12) Patent Application Publication
(10) Pub. No.: US 2025/0312732 A1
(43) Pub. Date: Oct. 9, 2025

(54) JANUS MESH FOR FOG HARVESTING AND METHOD OF MAKING THE SAME

(71) Applicant: The Hong Kong University of Science and Technology, Kowloon (CN)

(72) Inventors: KING LUN YEUNG, Kowloon (CN); JIAYU SONG, Sai Kung (CN)

(73) Assignee: The Hong Kong University of Science and Technology, Kowloon (CN)

(21) Appl. No.: 19/064,887

(22) Filed: Feb. 27, 2025

Related U.S. Application Data
(60) Provisional application No. 63/575,856, filed on Apr. 8, 2024.

(51) Int. Cl. B01D 53/28; B01D 67/00; B82Y 30/00; B82Y 40/00

(52) U.S. Cl. CPC B01D 53/28; B01D 67/0051; B82Y 30/00; B82Y 40/00; B01D 2257/80

(57) ABSTRACT

The Janus mesh for fog harvesting is a mesh with a superhydrophobic side and an opposed hydrophilic side. The Janus mesh is formed from a brass mesh with opposed first and second sides. The first side has the hydrophobic layer formed thereon and the second side has the hydrophilic layer formed thereon. The hydrophobic layer is formed from ZnO nanowires and stearic acid, and the hydrophilic layer is formed from just the ZnO nanowires. The Janus mesh is made by growing the ZnO nanowires on the first and second sides of the brass mesh using a calcining step. The first side of the brass mesh is sprayed with stearic acid to form the hydrophobic layer. The second side is treated with ultraviolet radiation to degrade any of the stearic acid that migrated to the second side via capillary action, thus forming the hydrophilic layer made from just the ZnO nanowires.

### CROSS-REFERENCE TO RELATED APPLICATIONS

This application claims the benefit of U.S. Provisional Patent Application No. 63/575,856, filed on Apr. 8, 2024.

### BACKGROUND

### Field

The disclosure of the present patent application relates to fog harvesting, and particularly to a mesh receiving element for harvesting water from fog.

### Description of Related Art

Approximately 2 billion people worldwide lack access to freshwater, and this number is expected to rise due to population growth, urbanization and climate change in the coming decades. In areas where freshwater sources are scarce and costly, fog harvesting is a promising technique. The most common design for fog collectors involves a mesh placed perpendicularly to a foggy wind. Upon impact, the incoming fog droplets adhere to the mesh fibers and coalesce, growing in size until they reach a critical point and fall due to gravity. Researchers have focused on improving the efficiency of mesh-based fog collectors by optimizing the geometric structures and surface wettability of the meshes. The Janus mesh, which has asymmetric wettability on each side, outperforms other fog collection systems with uniform wettability. This is due to the Janus mesh's unique unidirectional water transport feature, which allows water droplets to flow easily from the hydrophobic side to the hydrophilic side, but not vice versa. A droplet collected on the hydrophobic front can be rapidly transported to the hydrophilic back, preventing re-evaporation and replenishing the hydrophobic face to capture more water droplets, thus maximizing the fog collection rate.

The efficiency of Janus meshes in fog harvesting decreases over time due to the hydrophilic side undergoing a hydrophobic transition caused by the adsorption of non-polar airborne volatile organic compounds (VOCs). These VOCs can also mix with fog-laden air streams and can reside within fog droplets, raising concerns about the safety of harvested water. Photocatalytic nanomaterials, such as TiO₂ and ZnO, are environmentally friendly solutions for degrading these pollutants. When exposed to light of appropriate wavelengths, these nanomaterials generate electron-hole pairs that oxidize and degrade organic molecules. Currently, several studies have integrated photocatalytic materials into fog harvesting systems to enable the simultaneous collection and purification of fog water. However, there is a trade-off in combining fog harvesting and purification. A high fog harvesting rate requires a short fog collection time per unit mass, which is facilitated by hydrophobic surfaces. In contrast, the purification process requires a longer contact time and a larger contact area, making hydrophilic surfaces more suitable. Thus, a Janus mesh for fog harvesting and a method of making the same solving the aforementioned problems are desired.

### SUMMARY

The Janus mesh for fog harvesting is a mesh with a superhydrophobic side and an opposed hydrophilic side. The Janus mesh is formed from a mesh with opposed first and second sides. As non-limiting examples, the mesh may be a brass mesh or a brass-coated mesh. The first side has the hydrophobic layer formed thereon and the second side has the hydrophilic layer formed thereon. The hydrophobic layer is formed from ZnO nanowires and a hydrophobic coating, and the hydrophilic layer is formed from just the ZnO nanowires. As a non-limiting example, the hydrophobic coating may be stearic acid. The Janus mesh is made by growing the ZnO nanowires on the first and second sides of the brass mesh using a single calcining step. The first side of the brass mesh is sprayed with stearic acid to form the hydrophobic layer. The second side is treated with ultraviolet radiation to degrade any of the stearic acid that migrated to the second side via capillary action, thus forming the hydrophilic layer made from just the ZnO nanowires.

The superhydrophobicity and hydrophilicity of the Janus mesh, combined with photocatalytic activity, enable the Janus mesh to achieve high fog harvesting efficiency and an efficient photodegradation rate of organics. The contrasting wettability between its two faces transports collected fog droplets in a single direction from the superhydrophobic to the hydrophilic face of the mesh, even against gravity, thus, avoiding re-entrainment.

The Janus mesh rapidly degrades entrained organic pollutants (e.g., methylene blue) in the collected droplets under exposure to UV radiation, removing more than 94% of the contaminants. Additionally, the Janus mesh can disinfect 99.975% of bacteria (e.g., E. coli) that thrive in water and humid environments. The Janus mesh's self-cleaning properties make the Janus mesh resilient against airborne contaminants. Further, the photocatalytic activity of the ZnO nanowires may be attenuated by deposition of metals, semiconductors and nonmetals thereon to enhance the activity thereof, and also to adjust the wavelength for photoactivity, such as in the visible light spectrum.

These and other features of the present subject matter will become readily apparent upon further review of the following specification.

### BRIEF DESCRIPTION OF DRAWINGS

FIG. 1 is a perspective view of a Janus mesh for fog harvesting.

FIG. 2A shows a scanning electron microscope (SEM) image and energy-dispersive X-ray spectroscopy (EDX) images of a brass mesh used to make the Janus mesh for fog harvesting.

FIG. 2B shows an SEM image and EDX images of a ZnO-brass mesh used to make the Janus mesh for fog harvesting.

FIG. 2C is a graph showing X-ray diffraction results for the brass and ZnO-brass meshes.

FIG. 2D shows the ultraviolet-visible light (UV-Vis) absorbance spectra for the brass and ZnO-brass meshes.

FIG. 2E is a plot showing variation of water droplet contact angles on the front and back sides of the ZnO-brass mesh coated with stearic acid (SA-ZnO-brass mesh) as a function of UV irradiation time, where the volume of the sessile droplet is 7 μL.

FIG. 2F is a graph showing the mass percentages of Cu, Zn, O and C on the surfaces of the brass and ZnO-brass meshes, the front and back sides of the stearic acid-coated ZnO-brass mesh (SA-ZnO-brass front and SA-ZnO-brass back), and the front and back sides of SA-ZnO-brass after 24 hours of UV irradiation (SA-ZnO-brass front-UV24 h and SA-ZnO-brass back-UV24 h).

FIG. 3A is an SEM image showing the morphology of the ZnO-brass mesh surface.

FIG. 3B is an SEM image showing the morphology of the SA-ZnO-brass front.

FIG. 3C is an SEM image showing the morphology of the SA-ZnO-brass back.

FIG. 3D is an SEM image showing the morphology of the SA-ZnO-brass back-UV24 h. The scale bars represent 1 μm.

FIG. 4A is a time series of images of a 7 μL water droplet placed on the superhydrophobic (SHB) face of the Janus mesh, with a schematic drawing shown below, illustrating the droplet interaction with the mesh surface.

FIG. 4B is a time series of images of a 7 μL water droplet placed on the hydrophilic (HL) face of the Janus mesh, with a schematic drawing shown below, illustrating the droplet interaction with the mesh surface.

FIG. 4C is a time series of images of a 3.5 μL water droplet as it approaches the SHB (top) and HL (bottom) faces of the Janus mesh from underneath.

FIG. 4D is an image of the dispensed water droplet spontaneously transported from the superhydrophobic (SHB) side to the hydrophilic (HL) side, with a water contact angle of 57° indicated.

FIG. 4E is an image of the water droplet from FIG. 4D after flipping the Janus mesh vertically, showing a decreased water contact angle of 45°. The scale bars represent 1 mm.

FIG. 5A is plot illustrating the variation of water contact angles on the front and back sides of a SA-ZnO-brass mesh sample (Mesh1) as a function of the UV irradiation time.

FIG. 5B is plot illustrating the variation of water contact angles on the front and back sides of a SA-ZnO-brass mesh sample (Mesh2) as a function of the UV irradiation time.

FIG. 5C is plot illustrating the variation of water contact angles on the front and back sides of a SA-ZnO-brass mesh sample (Mesh3) as a function of the UV irradiation time.

FIG. 6A is a graph comparing the fog harvesting rate of meshes with different mesh openings, wire diameters and shade coefficients (Mesh1-Mesh4) and surface wettability (brass, superhydrophilic (SHL), superhydrophobic (SHB), and Janus), with brass foil as the control sample. The scale bars in the images represent 4 mm.

FIG. 6B is a graph comparing the accumulated amount of water from fog harvesting from the brass, SHL, SHB, and Janus Mesh2 samples over a period of five hours.

FIG. 6C diagrammatically illustrates the fog airstream from a fog generator outlet to the mesh surface, showing the fog stream intercepted by the mesh and the remaining fog that bypassed the harvesting unit.

FIG. 6D shows photographic images of the fog stream before and after passing through the Mesh1-Mesh4 and foil samples, with the foil serving as the control. The boxes indicate the location of the mesh or foil, and the arrows serve as visual guides for the direction of the fog streams. The scale bars in the images represent 30 mm.

FIG. 6E diagrammatically illustrates the droplet interactions with the surface of the wire mesh for the brass sample.

FIG. 6F diagrammatically illustrates the droplet interactions with the surface of the wire mesh for the SHL sample.

FIG. 6G diagrammatically illustrates the droplet interactions with the surface of the wire mesh for the SHB sample.

FIG. 6H diagrammatically illustrates the droplet interactions with the surface of the wire mesh for the Janus mesh.

FIG. 7A is a graph comparing the variations of fog harvesting amount as a function of time in 5 hours by Mesh1 with different kinds of wettability; i.e., brass (hydrophobic), superhydrophilic (SHL), superhydrophobic (SHB), and the Janus mesh.

FIG. 7B is a graph comparing the variations of fog harvesting amount as a function of time in 5 hours by Mesh3 with different kinds of wettability; i.e., brass (hydrophobic), superhydrophilic (SHL), superhydrophobic (SHB), and the Janus mesh.

FIG. 7C is a graph comparing the variations of fog harvesting amount as a function of time in 5 hours by Mesh4 with different kinds of wettability; i.e., brass (hydrophobic), superhydrophilic (SHL), superhydrophobic (SHB), and the Janus mesh.

FIG. 8A is a graph showing methylene blue (MB) concentration in water collected over 24 hours of fog harvesting under UV irradiation with the Janus mesh without UV, serving as control. The initial MB concentration in the fog (C₀) was 5 ppm.

FIG. 8B shows plots of MB removal efficiency (n) at different fog harvesting rates under UV with C₀=5 ppm.

FIG. 8C shows plots of MB concentration in collected water from the Janus mesh after 6 hours of fog harvesting under UV irradiation with C₀ ranging from 1 ppm to 20 ppm.

FIG. 8D illustrates the mechanism for photocatalytic degradation of MB on the ZnO nanowires under UV irradiation.

FIG. 8E is a graph showing MB removal efficiency (n) plots for different concentrations of a 1,4-benzoquinone chemical scavenger.

FIG. 8F is a graph showing MB removal efficiency (n) plots for different concentrations of a tert-butanol chemical scavenger.

FIG. 8G is a graph showing MB removal efficiency (n) plots for different concentrations of a potassium oxalate chemical scavenger.

FIG. 8H is a plot showing the intrinsic bactericidal activity of the Janus mesh's HL face.

FIG. 9A is a photographic image showing vertical liquid bridges formed on the SHL-Mesh4 sample after fog harvesting for 1 hour.

FIG. 9B is a photographic image showing the SHL-Mesh4 sample of FIG. 9A after drying and rotation by 90° clockwise for the fog harvesting test, with horizontal liquid bridges formed on the SHL-Mesh4 being shown.

FIG. 9C is a graph showing the fog harvesting rates of the SHL-Mesh4 sample with vertical liquid bridges and horizontal liquid bridges.

FIG. 10A shows the X-ray photoelectron spectroscopy (XPS) valence band spectra of the ZnO-brass mesh.

FIG. 10B shows a zoomed-in portion of FIG. 10A, showing the valence band spectra (−1 eV to 8 eV) to determine the valence band.

FIG. 11A shows the UV-Vis reflectance spectrum of the ZnO-Brass mesh.

FIG. 11B shows the band gap energy of the ZnO-Brass mesh determined from the Tauc plot.

FIG. 12A shows photographic images of the water droplet contact angle of the Janus mesh's HL and SHB faces before and after a 21-day fog harvesting operation and following 6 hours of UV regeneration treatment.

FIG. 12B shows plots for the water droplet contact angle of the Janus mesh's HL and SHB faces before and after the 21-day fog harvesting operation and following 6 hours of UV regeneration treatment.

FIG. 12C shows photographic images of a water droplet in contact with the Janus mesh's HL and SHB faces before and after deliberate contamination with oleic acid, and its UV regeneration.

FIG. 12D shows plots for the water droplet contact angle corresponding to FIG. 12C over five repeated contamination and regeneration cycles.

FIG. 12E shows photographic images of a water droplet in contact with an SHL non-photoactive CuO—Cu mesh before and after a 21-day fog harvesting operation and following 10 days UV regeneration treatment. The scale bars represent 1 mm.

FIG. 12F shows plots of the water contact angle corresponding to FIG. 12E.

FIG. 13A is a plot showing the variation of the water contact angle as a function of UV irradiation time on the Janus-hydrophilic side after contamination by the 21-day ambient VOC adsorption

FIG. 13B is a plot showing the variation of the water contact angle as a function of UV irradiation time on the Janus-hydrophilic side after contamination by oleic acid.

FIG. 14A is an SEM image of a cross-section of calcined copper mesh.

FIG. 14B is an SEM image of the top of the calcined copper mesh.

FIG. 14C is an EDX elemental map of Cu for the calcined copper mesh.

FIG. 14D is an EDX elemental map of O for the calcined copper mesh.

FIG. 14E is an EDX elemental map of C for the calcined copper mesh. The scale bars represent 5 μm.

FIG. 15 shows the irradiation spectrum of the UV lamps used in the manufacture of the Janus mesh.

FIG. 16A shows the UV-Vis spectrum of a 4 ppm methylene blue aqueous solution used for testing contamination of the Janus mesh.

FIG. 16B shows a fitted linear line showing the relationship between the methylene blue concentration and the absorption intensity at a wavelength of 664 nm.

Similar reference characters denote corresponding features consistently throughout the attached drawings.

### DETAILED DESCRIPTION

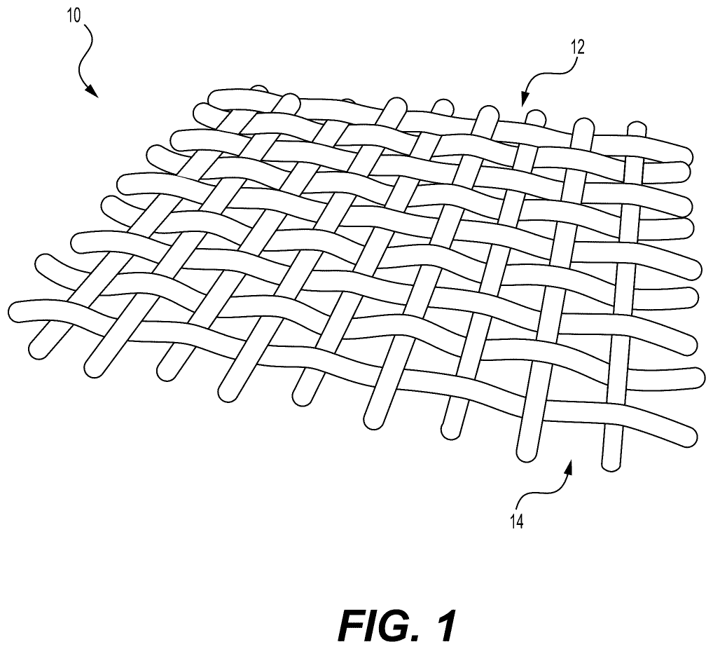

The Janus mesh for fog harvesting is a mesh with a superhydrophobic side and an opposed hydrophilic side. The Janus mesh 10 is formed from a mesh with opposed first and second sides 12, 14, respectively. It should be understood that the size and relative dimensions of Janus mesh 10, and the spacing of the mesh openings formed therein, as seen in FIG. 1, are shown for exemplary purposes only. As non-limiting examples, the mesh may be a brass mesh or a brass-coated mesh. The first side 12 has the hydrophobic layer formed thereon and the second side 14 has the hydrophilic layer formed thereon. The hydrophobic layer is formed from ZnO nanowires and a hydrophobic coating, and the hydrophilic layer is formed from just the ZnO nanowires. As a non-limiting example, the hydrophobic coating may be stearic acid.

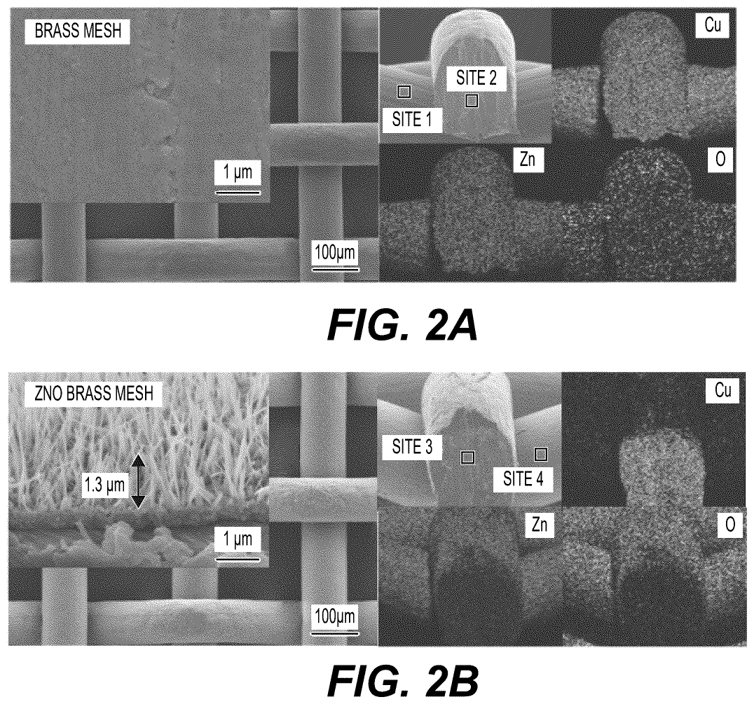

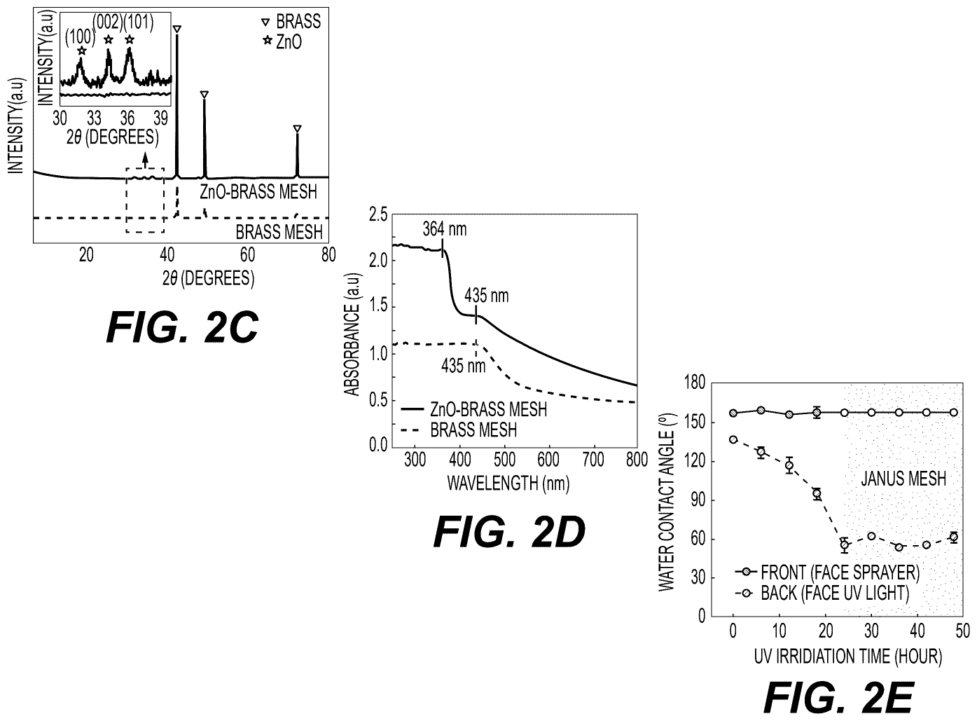

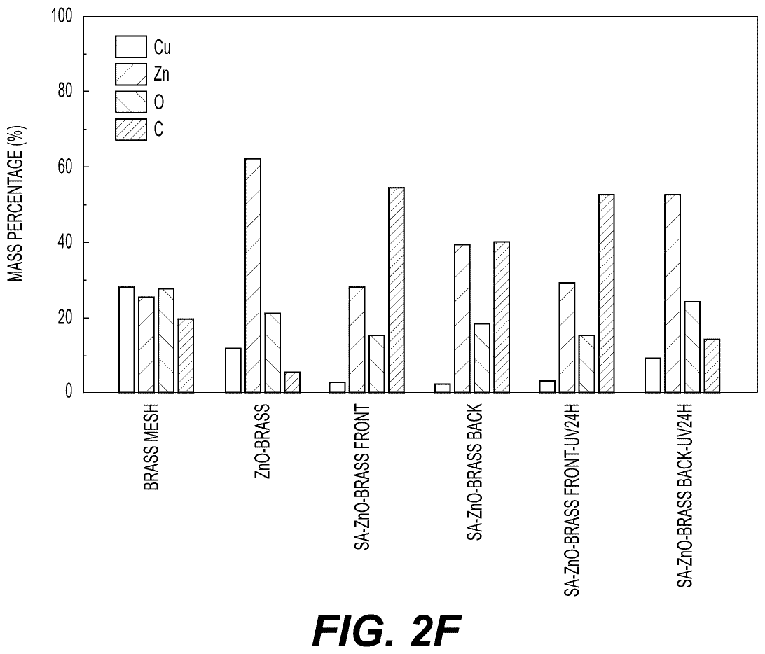

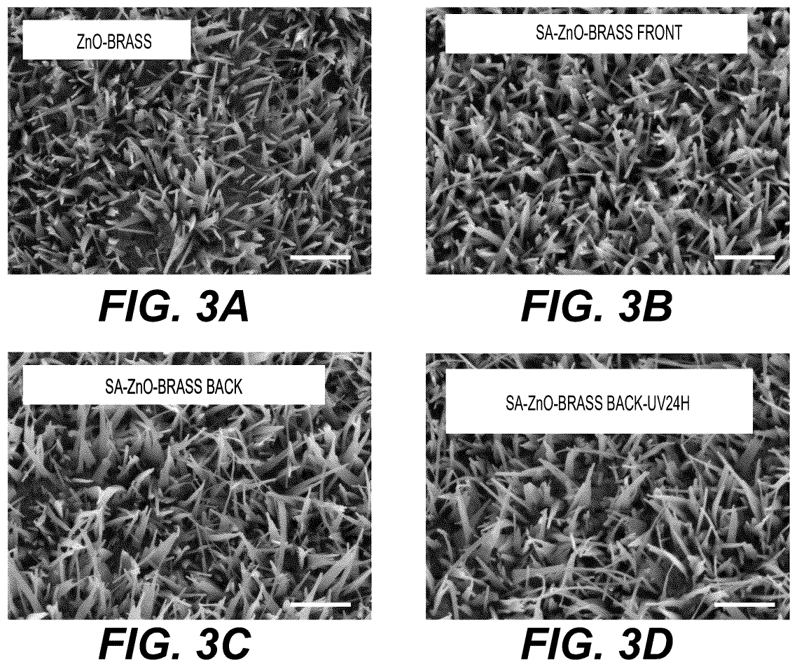

The Janus mesh 10 is made by growing photocatalytic ZnO nanowires on the first and second sides of the brass mesh using a single calcination step. The original brass mesh was hydrophobic, with an average water contact angle of 127±3°. However, after calcination and ZnO nanowire growth, the resulting ZnO-brass mesh became superhydrophilic, with a mean water contact angle of 19±4°. One side of the superhydrophilic mesh (i.e., the first side) was sprayed with an ethanol solution of stearic acid (SA), which is a hydrophobic agent, turning the surface superhydrophobic (SA-ZnO-brass front) with water contact angles of 157±3° (shown in FIG. 2E) without altering its morphology. FIG. 3A shows the morphology of the mesh surface of ZnO-brass and FIG. 3B shows the morphology of the SA-ZnO-brass front.

The mesh's back side (SA-ZnO-brass back) also became hydrophobic (136+) 2° due to the capillary spreading of the SA. This was confirmed by significantly increased C on the surface of the SA-ZnO-brass back, as indicated by the X-ray photoelectron spectroscopy (XPS) measurements in FIG. 2C. The hydrophilicity of the SA-ZnO-brass back was restored after 24 hours of ultraviolet (UV) irradiation (shown in FIG. 2E), with ZnO photodegrading the adsorbed SA. This resulted in a concomitant decrease in C (FIG. 2F) and a decrease of water contact angle to approximately 60°. The SA-ZnO-brass front surface remained superhydrophobic after UV treatment (SA-ZnO-brass front-UV24 h) with no discernible decrease in C content (FIG. 2F). FIG. 3C shows the morphology of the SA-ZnO-brass back, and FIG. 3D shows the morphology of the SA-ZnO-brass back-UV24 h. No obvious morphology change was observed after the spray coating and UV irradiation. The scale bars represent 1 μm.

The contrasting wettability between the front and back sides of the mesh rapidly draws water droplets dispensed on the superhydrophobic side to the hydrophilic side, resulting in unmeasurable water contact angles for the superhydrophobic surface (denoted by circles with the same values of 157° as observed at the 18th hour in FIG. 2E). The fabrication procedure is fully scalable and can be used to prepare large sheets of Janus mesh.

For purposes of testing, four different samples were prepared using four different types of brass mesh. Table 1 below shows the properties of the four brass mesh samples which were used (referred to as “Mesh1”, “Mesh2”, “Mesh3”, and “Mesh4”). In Table 1, the shade coefficient is the ratio between the wire area and the total mesh area.

TABLE 1
Physical Properties of Brass Mesh Samples

| | Mesh1 | Mesh2 | Mesh3 | Mesh4 |
|---|---|---|---|---|
| Pore size (μm) | 1901 ± 123 | 1029 ± 77 | 457 ± 18 | 160 ± 13 |
| Wire diameter | 282 ± 7 | 250 ± 13 | 175 ± 4 | 94 ± 2 |
| (μm) | | | | |
| Shade | 20 ± 1% | 37 ± 2% | 50 ± 3% | 60 ± 5% |
| coefficient | | | | |
| Mesh thickness | 555 ± 6 | 426 ± 16 | 339 ± 6 | 225 ± 4 |
| (μm) | | | | |
| Calculated η_{c} | 0.938 | 0.944 | 0.960 | 0.978 |
| Calculated ηₐ | 0.144 | 0.184 | 0.166 | 0.128 |
| Calculated ηₐη_{c} | 0.135 | 0.174 | 0.159 | 0.125 |

The Mesh4 brass mesh is smooth and composed mainly of Cu and Zn, as shown in FIG. 2A. The Zn/Cu weight ratios of the brass mesh surface (Site 1) and bulk (Site 2) are nearly identical, at around 0.7, as shown in Table 2 below. However, this distribution changes after calcination. As shown in FIG. 2B and Table 2, the bulk Zn/Cu weight ratio of the calcined mesh (Site 3) remains the same as the original mesh, while the surface (Site 4) is mainly composed of Zn, O and C elements in the form of nanowires, with an average length of 1.3±0.3 μm. X-ray diffraction confirms that the nanowires are ZnO crystals (FIG. 2C). Additionally, there is a simultaneous increase in the absorption at 364 nm, as shown in FIG. 2D, which is a characteristic of ZnO nanowires.

TABLE 2
Energy-dispersive X-ray spectroscopy (EDXS) Elemental Composition
of Brass (Sites 1 and 2) and ZnO-Brass (Sites 3 and 4)

| | Site 1 | Site 2 | Site 3 | Site 4 |
|---|---|---|---|---|
| Cu (%) | 54.38 | 52.44 | 54.26 | 0.00 |
| Zn (%) | 36.69 | 38.46 | 36.26 | 80.05 |
| O (%) | 1.56 | 0.00 | 1.53 | 14.50 |
| C (%) | 7.37 | 9.10 | 7.95 | 5.45 |

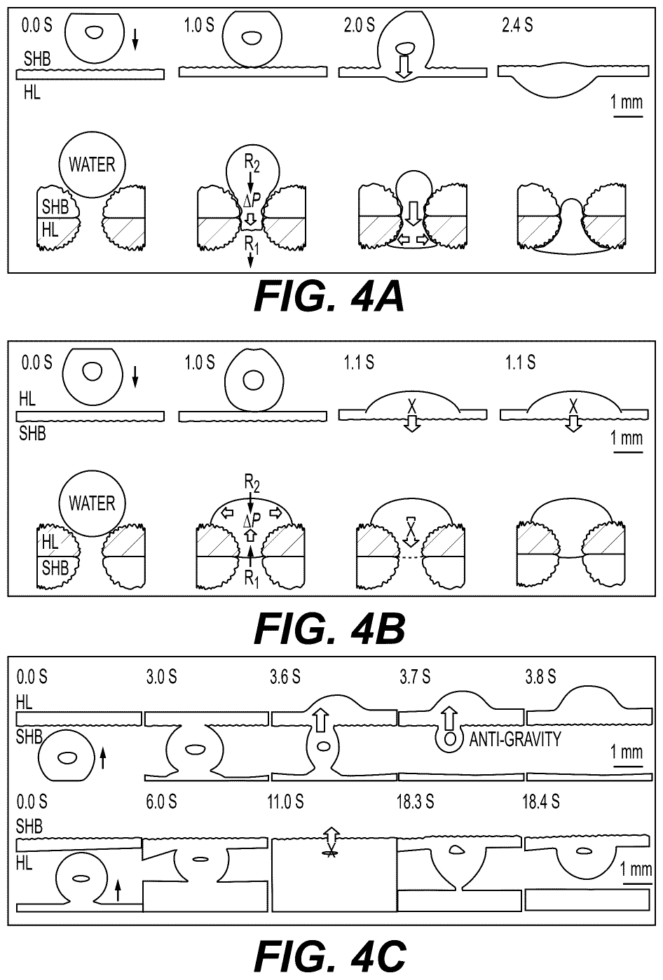

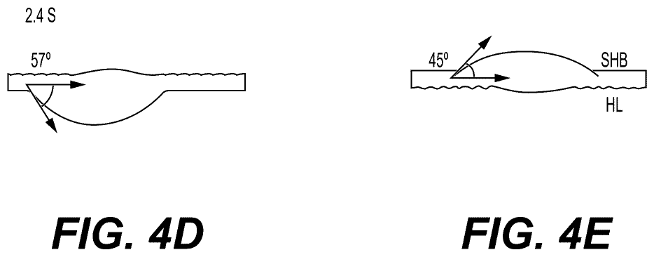

Unidirectional droplet flow on the Janus mesh was investigated by placing the mesh flat with the superhydrophobic (SHB) side facing up, as illustrated in FIG. 4A, and a 7 μL droplet was dispensed on the SHB surface. Due to the wettability gradient, the droplet quickly flowed through the mesh and spread on the hydrophilic (HL) side. This phenomenon is illustrated in FIG. 4A, where the water droplet is pulled to the HL side, generating a Laplace pressure gradient ΔP (indicated by the arrows). The Laplace pressure gradient is calculated using the formula

$$Δ P = \frac{2 γ}{{R}_{1}} - \frac{2 γ}{{R}_{2}} ,$$

where γ is the water surface tension, and R₁ and R₂ are the radii of curvature for the bottom and top menisci, respectively. The bottom meniscus is concave (R₁<0), and the top one is convex (R₂>0), resulting in a negative ΔP, representing a downward Laplace pressure gradient. The horizontal capillary force on the hydrophilic side, coupled with the Laplace pressure gradient, pulls the water droplet through the mesh to the HL backside.

In contrast, when a water droplet was placed on the Janus mesh with the HL side facing up, as shown in FIG. 4B, it did not flow through and exhibited diode characteristics. This is because an upward hydrophobic force was generated when a water droplet was dispensed on the hydrophilic side due to R₁<R₂, which prevented water penetration. It is important to note that the suspended droplet on the HL face (2.4 s in FIG. 4A) exhibited a larger water contact angle (57°) than the water droplet (48°) directly dispensed on the HL face (15 s in FIG. 4B) due to gravitational force. In fact, when the mesh in FIG. 4A was flipped, the new water droplet contact angle was 45° (shown in FIGS. 4D and 4E), like that observed in FIG. 4B.

The forces that drive the unidirectional droplet flow from the SHB to the HL face are strong enough to overcome the gravitational forces acting on the droplet, as demonstrated in FIG. 4C. FIG. 4C shows a 3.5 μL water droplet placed near the SHB face of the Janus mesh being pulled upward against gravity to the HL side by the Laplace pressure gradient and capillary force. On the other hand, a droplet of similar volume can adhere to the HL face of the Janus mesh, but it cannot penetrate the mesh to the opposite face, demonstrating the unidirectional flow of droplets.

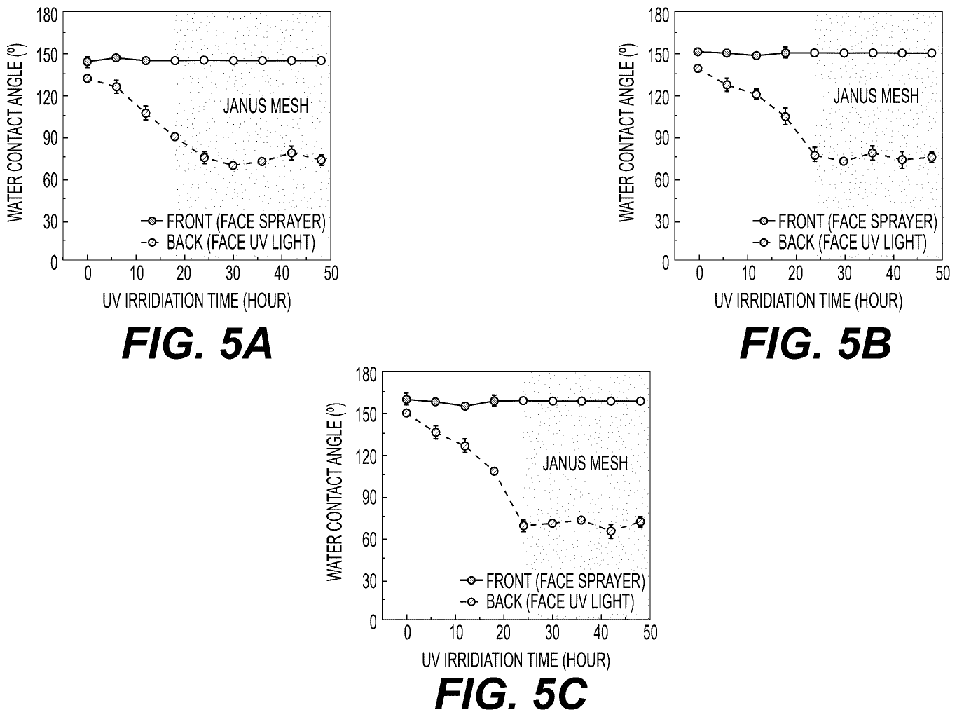

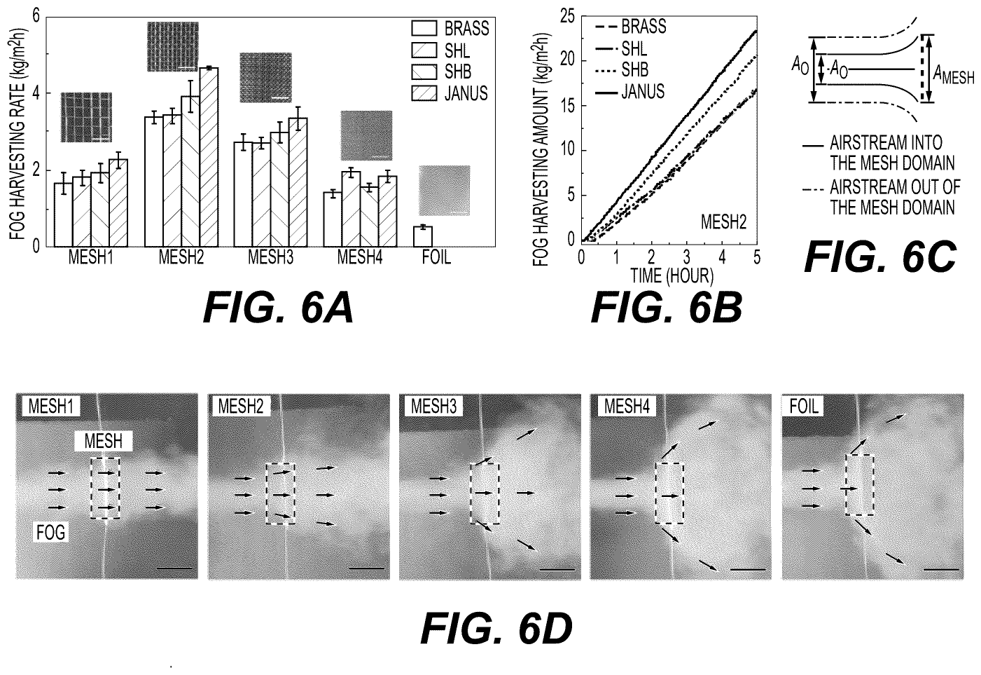

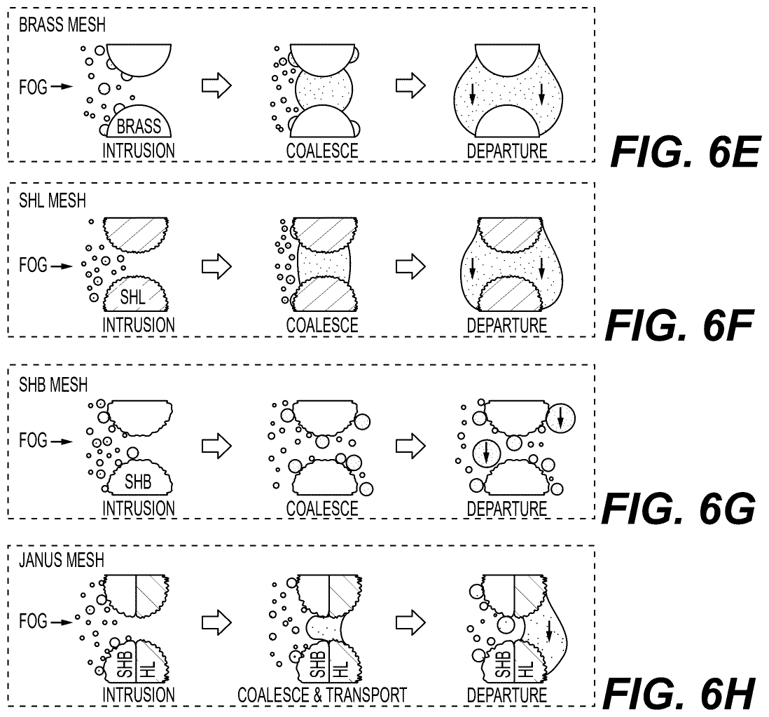

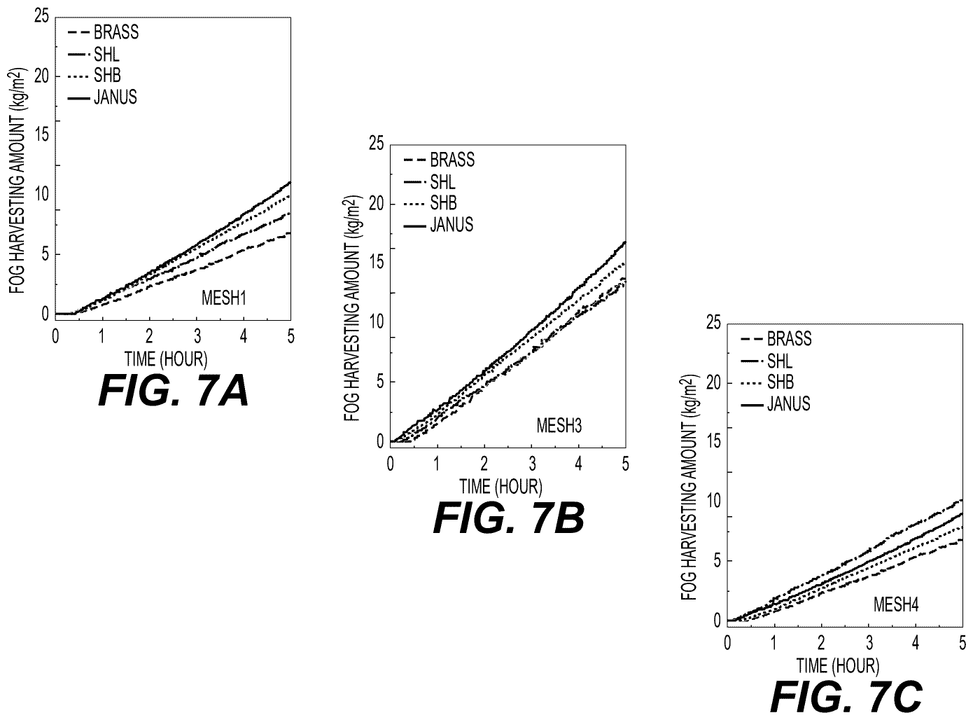

To test the Janus mesh 10 for use in fog harvesting, a 5×5 cm² Janus mesh was prepared, as described above, fixed vertically, and placed 8 cm from a fog generator. The collected fog droplets drained into a glass container, and their weight was recorded in real-time. The study examined the effects of geometric parameters (using all four mesh samples, Mesh1-4) and surface wettability (plain brass, the superhydrophilic surface (SHL), the superhydrophobic surface (SHB), and the overall Janus mesh) of the meshes on the fog harvesting efficiency. The pristine brass Mesh1-4 samples were hydrophobic (HB), and the corresponding calcined ZnO-brass Mesh1-4 samples were superhydrophilic (SHL). After stearic acid treatment, the SA-ZnO-brass Mesh1-4 samples were superhydrophobic (SHB). The detailed water contact angle results are presented below in Table 3. The Janus Mesh1-4 samples were obtained by exposing one side of the SA-ZnO-brass Mesh1-4 samples to UV (see FIGS. 5A-5C for Mesh1-3, respectively, and FIG. 2E for Mesh4). The fog harvesting rates are presented in FIG. 6A, and the accumulated weights of the harvested water with time are shown in FIGS. 6B, 7A, 7B and 7C.

TABLE 3
Water Contact Angles

| | Mesh1 | Mesh2 | Mesh3 | Mesh4 |
|---|---|---|---|---|
| Brass | 110 ± 4° | 118 ± 2° | 123 ± 2° | 127 ± 3° |
| (hydrophobic) | | | | |
| ZnO-Brass | 40 ± 4° | 25 ± 3° | 28 ± 3° | 19 ± 4° |
| (SHL) | | | | |
| SA-ZnO-Brass | 147 ± 3° | 152 ± 3° | 160 ± 4° | 157 ± 3° |
| (SHB) | | | | |

It is noted that, due to the unidirectional droplet transportation phenomenon, the water contact angles after 18 hours of UV irradiation on Mesh1, and 24 hours on Mesh2 and Mesh3, were not measurable. However, the XPS result (FIG. 2F) proved that the organic coating on the front side was not affected by the UV irradiation, indicating its unchanged water contact angles. Thus, the water contact angles after 18 hours of UV irradiation on Mesh1, and 24 hours on Mesh2 and Mesh3, are represented by circles with the same values as the one observed at the 12th and 18th hour, respectively. The volume of the sessile droplet was 35 μL for Mesh1 because of the large holes. The volume of the sessile droplet was 10 μL for Mesh2 and Mesh3.

Mesh opening, wire diameter, and shade coefficient differed between the Mesh1-4 samples. The results showed that as the hole opening decreased from Mesh 1 to Mesh 4, the fog harvesting rate initially increased, but decreased for finer mesh than Mesh 2, with the foil collecting the least amount of water. Surface wettability did not affect the results, as demonstrated by the samples in FIG. 6A.

The fog-harvesting efficiency, η_{f}, was calculated from aerodynamic efficiency ηₐ, capture efficiency η_{c}, and drain efficiency ηₐ as η_{f}=ηₐη_{c}η_{d}. The capture efficiency η_{c} is strongly related to the mesh wire radius, R_{c}. Their values were calculated for Mesh1-4 using a fog droplet radius R_{c} of 10 μm and the values give above in Table 1 as follows:

$${η}_{c} = \frac{St}{St + \frac{π}{2}} , where St = \frac{2 {R}_{d}^{2} {ρ}_{w} U}{9 {η}_{g} {R}_{c}}$$

is the Stokes number, where R_{d} is the droplet radius, ρ_{w} is the water density, U is the airspeed, η_{g} is the air viscosity, and R_{c} is the mesh wire radius.

The aerodynamic efficiency ηₐ measures the fraction of fog droplets captured after colliding with the mesh, and is calculated as

$${η}_{a} = ( \frac{{A}_{0}}{{A}_{mesh}} ) SC ,$$

where Aₘₑₛₕ is the mesh area, A₀ is the area of the air stream that can flow through the mesh (visualized by the streamline in FIG. 6C). SC is the shade coefficient; i.e., the ratio between the wire and total mesh areas (SC=1 for foil). Theory predicts that at low SC, increasing SC enhances ηₐ as the wire area for fog interception increases. Mesh2 showed a higher fog harvesting rate than Mesh1 because of higher ηₐη_{c}. However, further increasing SC reduced the fog harvesting efficiency due to higher flow resistance through the mesh openings (see FIG. 6D), leading to lower ηₐ. The ηₐ was quantified using a simplified equation:

$$\frac{sc}{1 + [ 1.22 ( 1.3 SC + {( \frac{SC}{1 - SC} )}^{2} ) ]} .$$

See also Table 1.

Mesh wettability affects the fog harvesting rate, as shown in FIG. 6B, and is illustrated in FIGS. 6E-6H for Mesh2. The original brass Mesh2 was hydrophobic, with a surface contact angle of 118±2° for water droplets. In contrast, the ZnO-brass Mesh2 was superhydrophilic (SHL), while the SA-ZnO-brass Mesh2 was superhydrophobic (SHB). The Janus Mesh2 sample had one hydrophilic (HL) face and one SHB face. On the hydrophobic brass mesh (FIG. 6E), water droplets accumulated on the wire mesh until a water bridge formed between neighboring wires, resulting in a large droplet held in place by capillary action. This essentially clogged the mesh, perturbing the airflow and resulting in lower ηₐ. Meanwhile, fog droplets fully wet the superhydrophilic ZnO-brass wires in FIG. 6F, and their accumulation eventually led to the forming of a water bridge between neighboring mesh wires. The capillary action prevented water from shedding from the clogged mesh, resulting in poorer water harvesting performance.

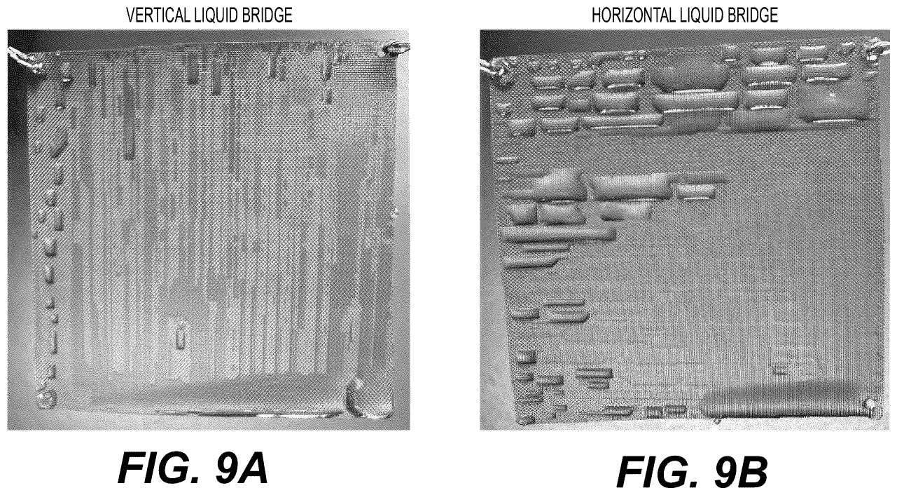

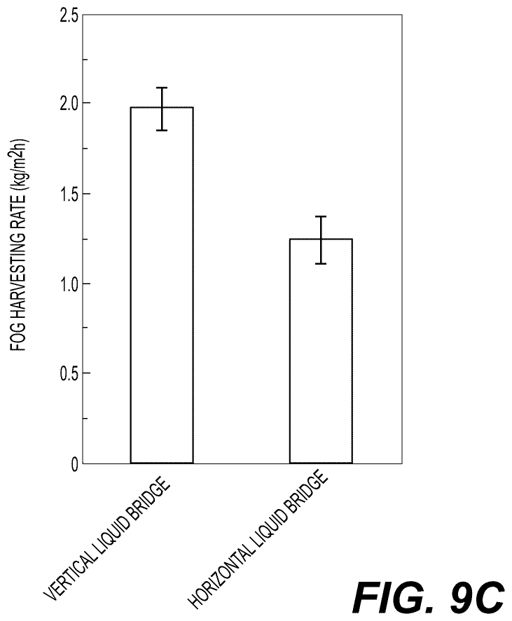

As shown in FIG. 6B, the SHB SA-ZnO-brass and Janus Mesh2 samples outperformed both brass and SHL ZnO-brass Mesh2 in fog harvesting. This was attributed, in part, to the superhydrophobicity of the mesh surface facing the incoming fog stream, as shown in FIGS. 6G and 6H. The poor surface wetting prevented water droplets from adhering to the wire and allowed droplets to be easily shed. On the SHB mesh, the re-entrainment of a portion of shed droplets in the air stream resulted in less water harvested. With its unidirectional transportation property, the Janus mesh effectively reduced water loss from back-streaming. On the Janus mesh, fog droplets were continuously intercepted and captured on the superhydrophobic face, then unidirectionally transported, collected, and drained on the hydrophilic face, as shown in FIG. 6H. Consequently, this yielded the best harvesting rate at a roughly 37% improvement over the unmodified brass mesh. This is a consistent observation over the range of mesh sizes investigated, except for ZnO-brass Mesh4, where the formation of connected vertical water bridges facilitated rapid water drainage (see FIGS. 9A-9C), which enhanced water drainage.

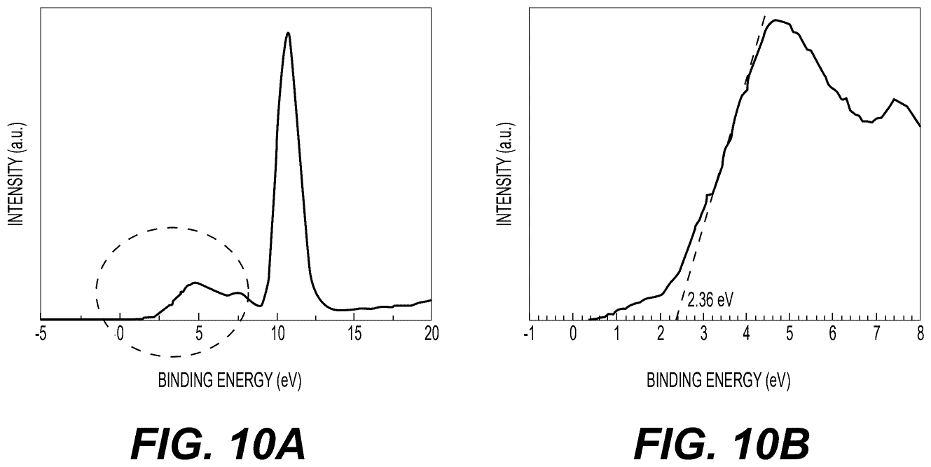

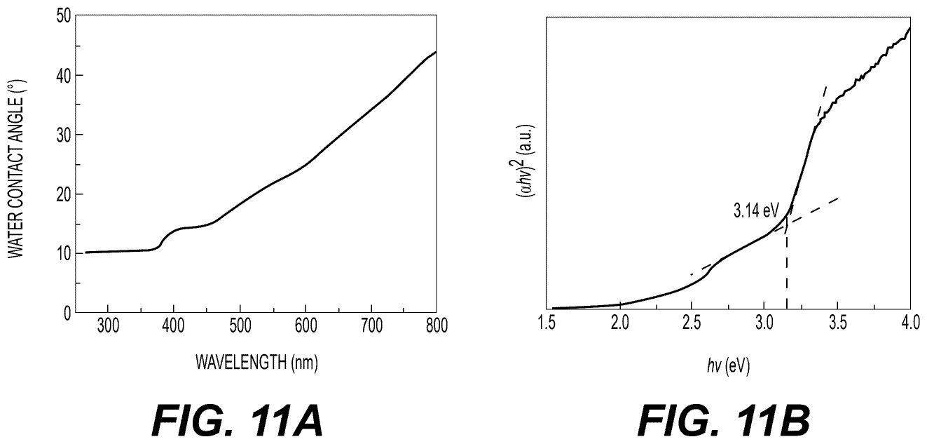

Purification of harvested water is crucial to remove pollutants that may be entrained in fog droplets. The Janus mesh's HL face is composed of photoactive ZnO nanorods that can degrade organic pollutants when irradiated with ultraviolet light. It also can kill microbes and disinfect water. The ZnO nanorods have a bandgap of 3.14 eV, with a valence band of 2.36 eV (see FIGS. 10A and 10B) and a conduction band of −0.78 eV (see FIGS. 11A and 11B), generating hydroxyl and superoxide radicals when irradiated with UV light. Testing was performed using equipment similar to that described above for fog harvesting, but with the addition of a UV light unit on the HL face of the mesh. During the fog harvesting process, UV lights were turned on to trigger the photocatalytic activity of the ZnO nanowires for pollution treatment and microbial disinfection.

In FIG. 11B, the band gap energy of the ZnO-brass mesh is determined from the Tauc plot. The Tauc method is based on the equation

$${( α hv )}^{\frac{1}{γ}} = B ( hv - {E}_{g} ) ,$$

where α is the absorption coefficient, h is the Planck constant, v is the photon's frequency, E_{g} is the band gap energy, B is a constant, and γ equals ½ for the direct transition band gap and 2 for the indirect band gap. Therefore, γ equals ½ for ZnO, which has a direct band gap. The α is calculated based on the equation

$$α = \frac{{( 1 - R )}^{2}}{2 R} ,$$

where R is the reflectance measured by UV-Vis as shown in FIG. 11A. Therefore, hv is plotted versus (αhv)². Apart from applying a linear fit to the fundamental peak, a linear fit used as an abscissa is applied for the slope below the fundamental absorption. The intersection of the two fitting lines gives the band gap energy estimation, which is 3.14 eV.

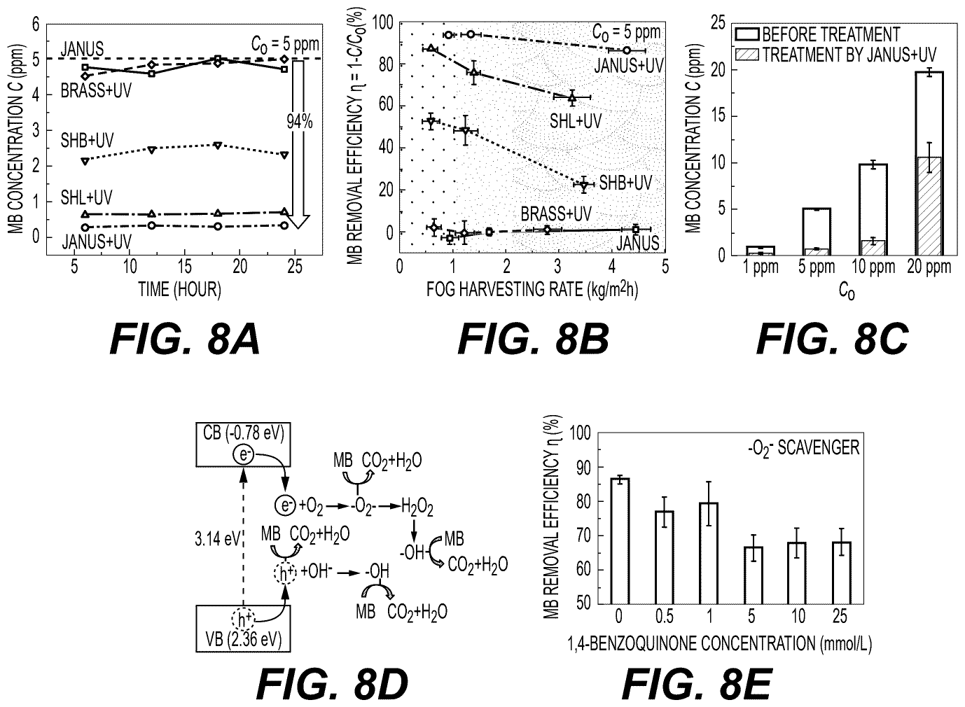

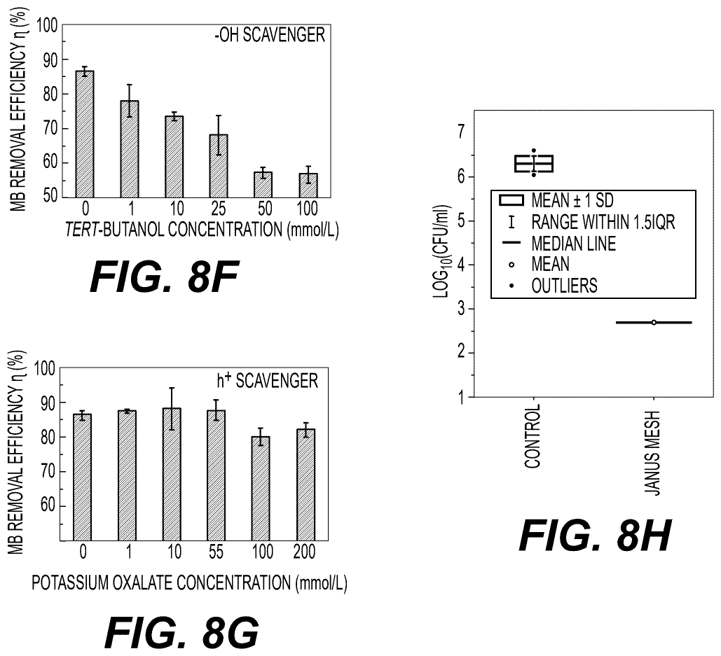

Photocatalytic degradation of organic pollutants was demonstrated for methylene blue (MB), as a model pollutant. The fog flowrate was 0.08±0.01 L·h⁻¹, and the airflow was 0.30±0.13 m·s⁻¹. Additionally, the fog droplet was contaminated with 5.00±0.12 ppm MB in the experiments. The harvested water was weighed, analyzed by a UV-Vis spectrometer, and the results are shown in FIG. 8A. There was no significant degradation of MB dye, and the water collected by the plain brass mesh remained blue in color. Brass has insignificant photocatalytic activity, and the results show that UV irradiation alone degrades the pollutant very slowly. In contrast, the SHL ZnO-brass mesh achieved 86.6% MB degradation under UV, resulting in a decrease in MB concentration in the purified water to 0.67±0.04 ppm. The harvested water retained a light blue tint.

The superhydrophobic SA-ZnO-brass mesh also exhibited photocatalytic activity, but only droplets on the irradiated side of the mesh were decolorized. As a result, the harvested water displayed a darker color, and the overall decrease in MB concentration (52.7%) was considerably less than that achieved by the SHL mesh. The poorer performance of the SA-ZnO-brass mesh can be attributed to the lower photocatalytic activity of SA-modified ZnO nanorods, as the SA molecules can occupy the active sites. Additionally, on the SHB mesh, captured fog forms discrete droplets on both faces of the mesh (see FIG. 6G), and only the irradiated face was degraded. In contrast, the intercepted water droplets on the SHL mesh form a water bridge that extends between the two faces of the mesh, allowing for photodegradation over the entire droplet.

A 94% MB photodegradation was realized on the Janus mesh under UV and its high performance is related to its rapid unidirectional flow of captured fog from the SHB face to the photocatalytic HL face, where the organic pollutants were photodegraded. In addition to having the best purification performance, it also displayed the highest fog harvesting rate. Without UV irradiation, MB removal was insignificant in the harvested water of the Janus mesh, as shown in FIG. 8A.

Water Purification and fog harvesting rate depend on the fog flowrate, which was adjusted to 0.08±0.01 L·h⁻¹, 0.12±0.02 L·h⁻¹, and 0.22±0.04 L·h⁻¹ to obtain low, medium, and high fog harvesting rates, respectively. The corresponding MB photocatalytic removal rates were measured under these conditions. FIG. 8B shows the relationship between fog harvesting rate and the MB removal efficiency

$$( η = 1 - \frac{c}{{c}_{0}} )$$

on the different meshes. Increasing the fog flowrate and velocity resulted in a higher fog harvesting rate and a shorter residence time of droplets on the meshes. Brass is not a photocatalyst and was inactive under UV irradiation. Similarly, the Janus mesh was inactive without UV irradiation. Thus, no discernible MB removal under these two conditions over the measured range of fog harvesting rate is observed in FIG. 8B. However, the SHL mesh, the SHB mesh, and the Janus mesh photodegraded MB when exposed to UV lights. The MB removal efficiency for each sample decreased with an increase in fog harvesting rate due to the shorter droplet residence time. Nevertheless, compared to SHB and SHL, the Janus mesh exhibited the highest fog harvesting rate and the highest MB removal efficiency.

Pollutant concentration in fog droplets is another factor influencing the photodegradation rate on the Janus mesh. To investigate this, fog contaminated with different MB concentrations was generated at a flowrate of 0.22±0.04 L·h⁻¹. FIG. 8C shows that fog droplets contaminated with less than 10 ppm MB can be effectively purified under UV, resulting in removal of 0.7 and 8.16 ppm MB from fogs contaminated with 1.00 and 10.00 ppm MB, respectively. However, a rate-limiting reaction was reached at 20 ppm MB, with only a marginal increase in MB removal of 9.15 ppm. To achieve higher removal rates, it would be necessary to increase photocatalyst efficiency or the UV intensity.

The photocatalytic degradation of MB occurs through a series of steps, as depicted in FIG. 8D. When ZnO nanorods absorb energetic photons, they excite electrons (e⁻) from the valence band to the conduction band, leaving a hole (h⁺) behind. The oxidation potential of the photogenerated holes (2.36 V) is greater than the potential of E⁰(·OH/H₂O)=2.27 V, resulting in the generation of hydroxyl radicals (·OH) via H₂O oxidation. Additionally, superoxide radicals (·O₂⁻) are formed due to the more negative redox potential of CB electrons (−0.78 V) compared to the potential of E0(·O₂⁻/O₂)=−0.28 V. The superoxide radical can undergo further reactions to produce hydroxyl radicals.

The role of ·O₂⁻, h⁺, and ·OH in MB degradation was investigated using the chemical scavengers 1,4-benzoquinone, potassium oxalate and tert-butanol. Experiments were conducted by introducing different concentrations of scavengers to 5 ppm MB contaminated fog and measuring its photodegradation by the Janus mesh under UV irradiation. The corresponding MB removal efficiencies were calculated and are summarized in FIGS. 8E, 8F and 8G. The results showed a notable inhibitory effect on the MB removal when 1,4-benzoquinone was added, as it trapped the ·O₂⁻ radicals. The MB removal efficiency decreased from 86.3% to 66.3% as the concentration of 1,4-benzoquinone increased to 5 mmol·L⁻¹. Further increasing the concentration of 1,4-benzoquinone did not result in any additional reduction of the MB removal efficiency. Tert-butanol caused more inhibition, decreasing MB removal efficiency to 56.7%. Adding potassium oxalate had only a slight effect on the MB removal efficiency. These findings indicate that the most active species during the photodegradation process is. OH, followed by ·O₂⁻ with the least contribution from h⁺.

The antimicrobial property of the Janus mesh was examined for E. coli following ASTM E3160-18: Standard Test Method for Quantitative Evaluation of the Antibacterial Properties of Porous Antibacterial Treated Articles. While UV irradiation is known for its effectiveness in disinfecting water of microbes, FIG. 8H shows that even without UV irradiation, the ZnO nanowires on the HL face of the Janus mesh were able to achieve a 3.60 log (99.975%) reduction of E. coli within an hour of contact. This demonstrated that ZnO nanorods possess inherently bactericidal properties, which may be due to the reactive oxygen species generated by ZnO nanorods damaging the organic biomolecules and resulting in bacterial death. Therefore, in addition to its ability to protect harvested water from bacteria, the Janus mesh's antimicrobial properties can contribute to sustained fog harvesting efficiency by preventing biofouling.

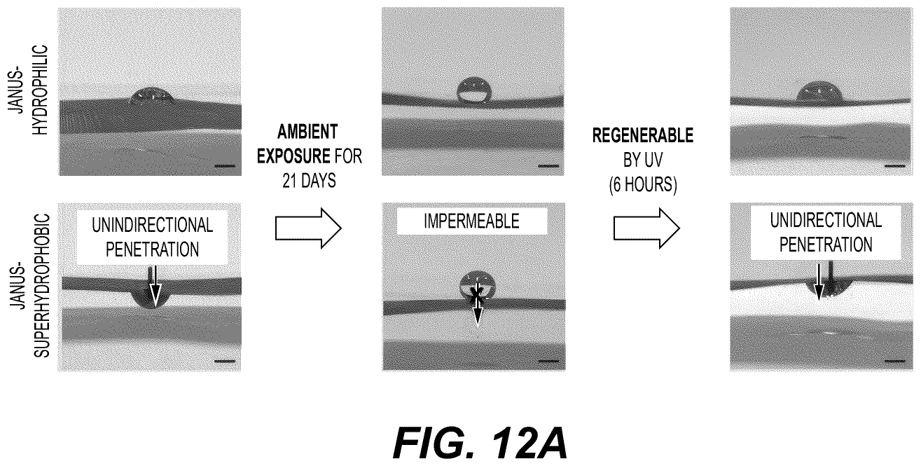

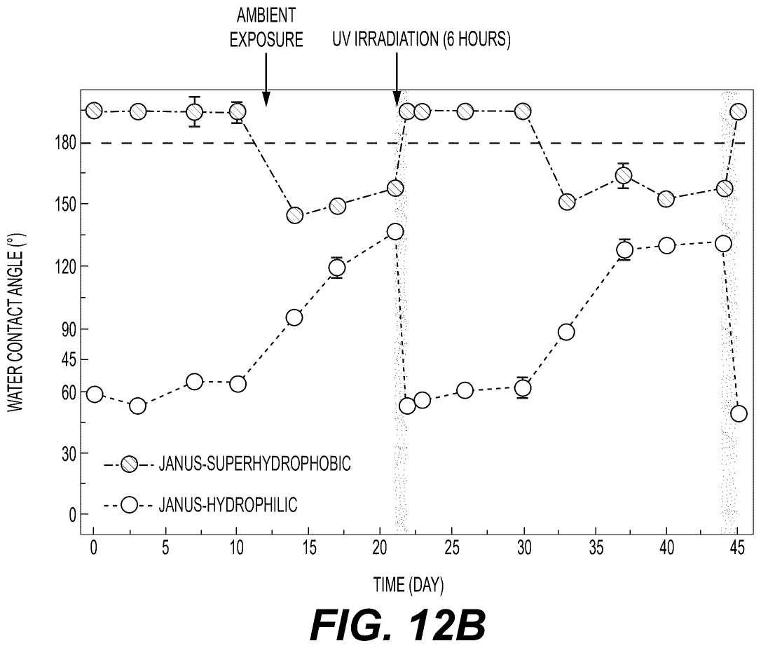

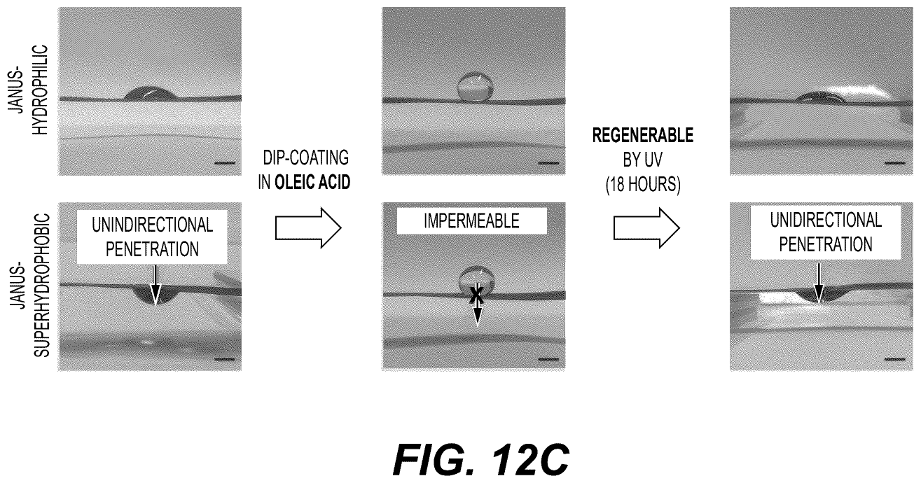

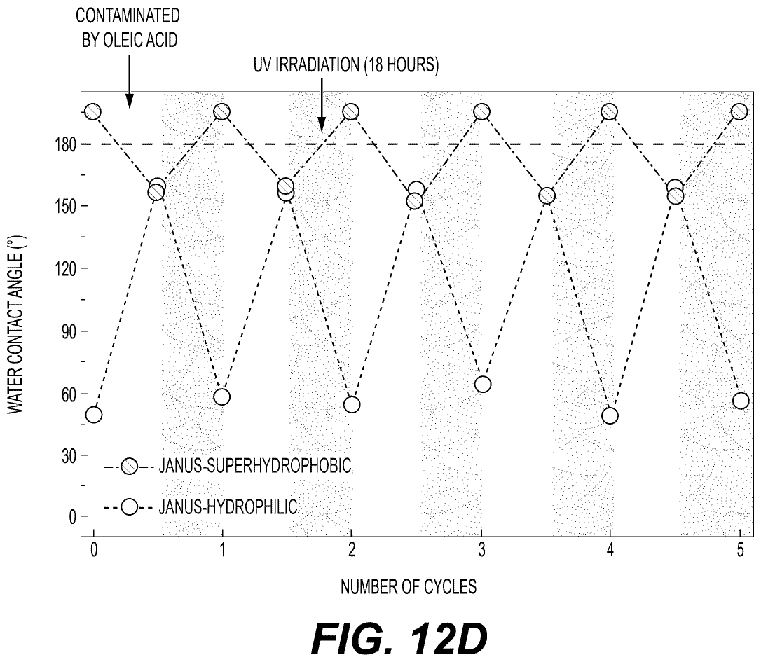

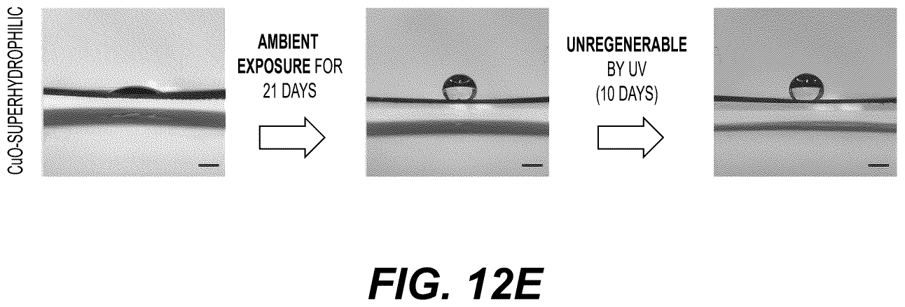

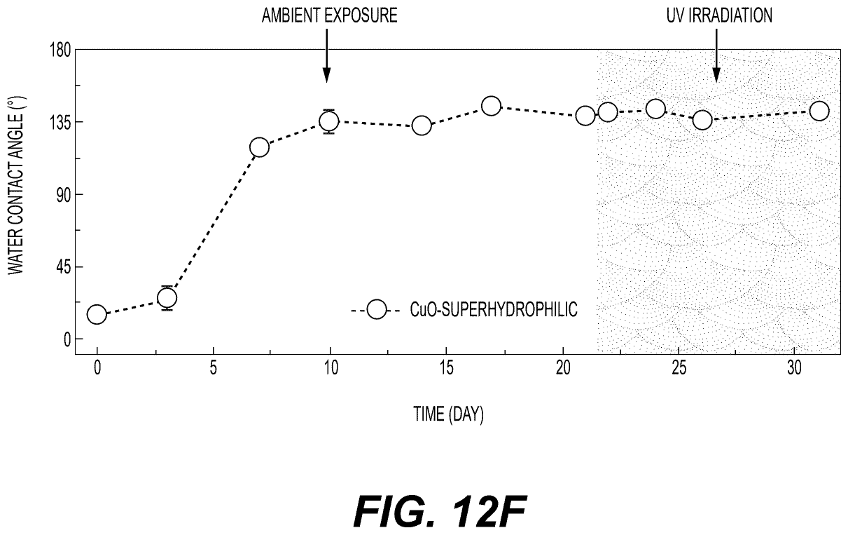

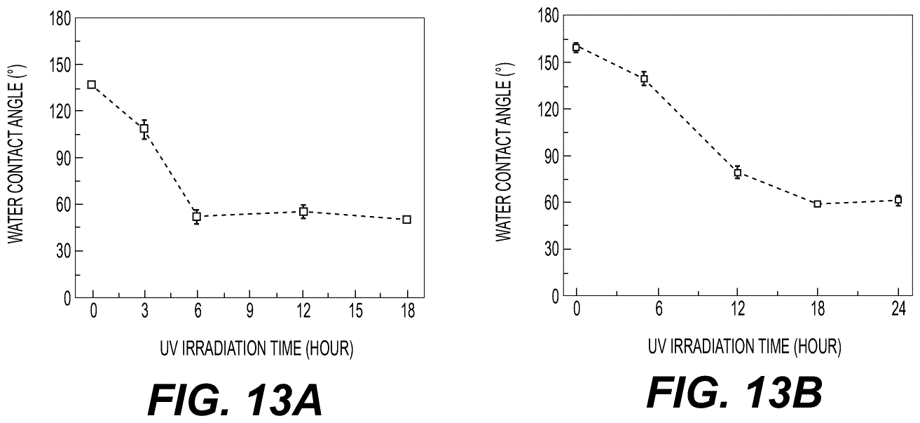

Airborne organic contaminants can gradually render the HL face of the Janus mesh hydrophobic, which diminishes its fog harvesting rate. As shown in FIG. 12A, the water contact angle on the HL face (Janus-hydrophilic) gradually increased from 58° to 137° (shown in FIG. 12B) after a continuous operation of 21 days. This resulted in the Janus mesh losing its ability to facilitate unidirectional droplet penetration, and water droplets could no longer pass through the mesh. However, the Janus mesh is regenerable. When exposed to UV illumination for 6 hours (see FIG. 13A), the hydrophilicity was recovered, with a water contact angle of 52°. The Janus mesh regained its capacity for one-way water droplet transportation (see FIG. 12A), and this surface regeneration process was repeatable, as shown in FIG. 12B. FIGS. 12E and 12F are photographs and plots, respectively, of the water droplet in contact with the SHL non-photoactive CuO—Cu mesh before and after the 21-day fog harvesting operation, and following 10 days of UV regeneration treatment. The scale bars represent 1 mm.

The regenerability of the Janus mesh was investigated by deliberately contaminating the surface with long-chain oleic acid, which transformed the HL face into a superhydrophobic surface with a water contact angle of 159°, preventing water from passing through the mesh, as shown in FIGS. 12C and 12D. After UV irradiation, the surface regained its hydrophilic properties (see FIG. 13B), and the Janus mesh recovered its ability to facilitate unidirectional water transport. This process was repeated five times without significant deterioration in water harvesting rate (1.96±0.21 kg·m⁻²·h⁻¹).

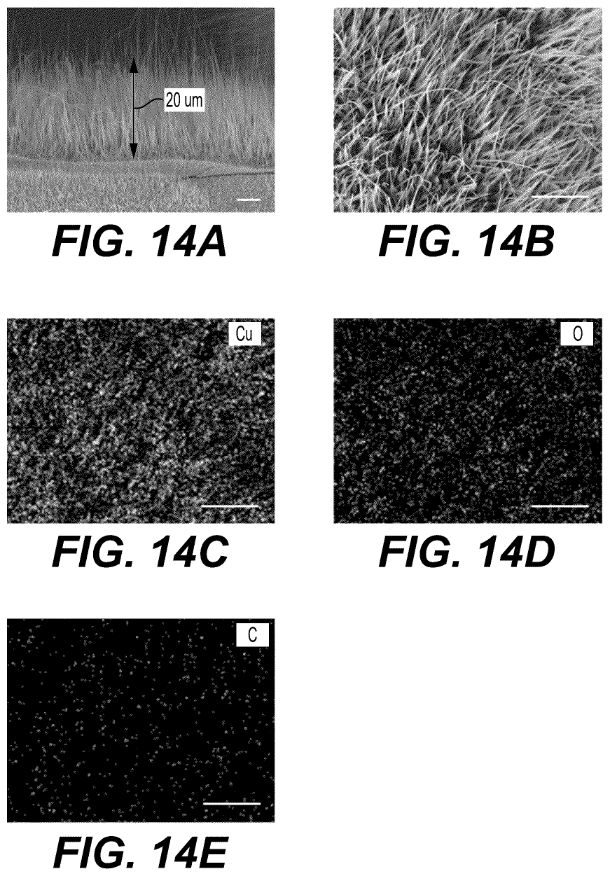

In contrast, replacing the photocatalytic ZnO nanorods with inactive CuO nanorods, as shown in FIGS. 14A-14E, showed that UV irradiation alone was insufficient to remove and degrade adsorbed organic pollutants. During the 21 days of fog harvesting operation, the surface gradually became hydrophobic, with the water droplet contact angle increasing to 135°. Unlike ZnO nanorods, the surface remained hydrophobic even after 10 days of UV exposure. These findings emphasize the importance of incorporating photocatalytic materials into the hydrophilic side of the Janus mesh to ensure its long-term water harvesting performance. For the calcined copper mesh shown in FIGS. 14A-14E, the carbon (C) had a wt % of 12.06, the oxygen (O) had a wt % of 20.62, and the copper (Cu) had a wt % of 67.32.

The superhydrophobicity and hydrophilicity of the Janus mesh, combined with photocatalytic activity, enable the Janus mesh to achieve high fog harvesting efficiency and an efficient photodegradation rate of organics. The contrasting wettability between its two faces transports collected fog droplets in a single direction from the superhydrophobic to the hydrophilic face of the mesh, even against gravity, thus, avoiding re-entrainment. It is noted that the Janus mesh demonstrated the highest fog harvesting rate among the original brass, superhydrophilic (ZnO-brass), and superhydrophobic (SA-ZnO-brass) meshes, with a 37% increase compared to the brass mesh. The unidirectional droplet flow in the Janus mesh, coupled with droplet wetting of the photocatalyst, resulted in rapid photodegradation of organic contaminants in harvested water droplets. Its inherent antimicrobial properties can maintain high bactericidal activity against water pathogens, such as E. coli (99.975% reduction), and also prevent biofilm formation. Thus, the Janus mesh can provide a reliable and sustainable source of clean water. The Janus mesh's efficient fog harvesting and its photocatalytic and antibacterial properties have applications in filtration, separation and wastewater treatment. Further, the photocatalytic activity of the ZnO nanowires may be attenuated by deposition of metals, semiconductors and nonmetals thereon to enhance the activity thereof, and also to adjust the wavelength for photoactivity, such as in the visible light spectrum.

For the above tests, the superhydrophilic ZnO nanowires on the brass mesh (ZnO-brass, SHL) were prepared using ASTM C27400 woven brass mesh. The mesh was first washed with deionized distilled water to remove dirt and degreased with acetone (>99.8%) followed by ethanol (>99.9%) for ten minutes under ultrasonication. The clean mesh was then placed in a Carbolite® CWF 11/13 muffle furnace and heated at a rate of 25° C.·min⁻¹ to 500° C., where it was kept for two hours. Afterward, the air-calcined brass mesh was removed after the furnace cooled back to room temperature. The yellow brass turned a brown color following the treatment process but retained its overall mechanical properties.

The resulting sample was found to be superhydrophilic (<40°) according to water droplet contact angle measurement performed using an Attension® Theta flow tensiometer manufactured by Biolin Scientific®. In addition, the sample was characterized by scanning electron microscopy equipped with energy dispersive X-ray spectroscopy and powder X-ray diffractometer to determine its microstructure, composition, and crystal structure. The elemental surface composition was analyzed by X-ray photoelectron spectrometer to analyze the surface elemental composition. The valence band of the sample was also determined by XPS, while the bandgap was investigated using a PerkinElmer® Lambda 1050+UV-visible NIR spectrophotometer by analyzing its UV-vis absorbance spectra.

The superhydrophobic ZnO-Brass mesh (SA-ZnO-brass, SHB) was obtained by treating ZnO-brass with stearic acid. To prepare the solution, 0.14 g stearic acid (95%) was dissolved in 100 mL absolute ethanol (>99.9%) to create a 5.0 mmol·L⁻¹ stearic acid/ethanol solution. The stearic acid solution was then sprayed onto the mesh using a sprayer with an orifice diameter of 0.8 mm, at a distance of 80 cm from the mesh. A milliliter of the 5 mmol·L⁻¹ stearic acid solution was deposited following five sprays, with a minute interval between sprays to allow for drying.

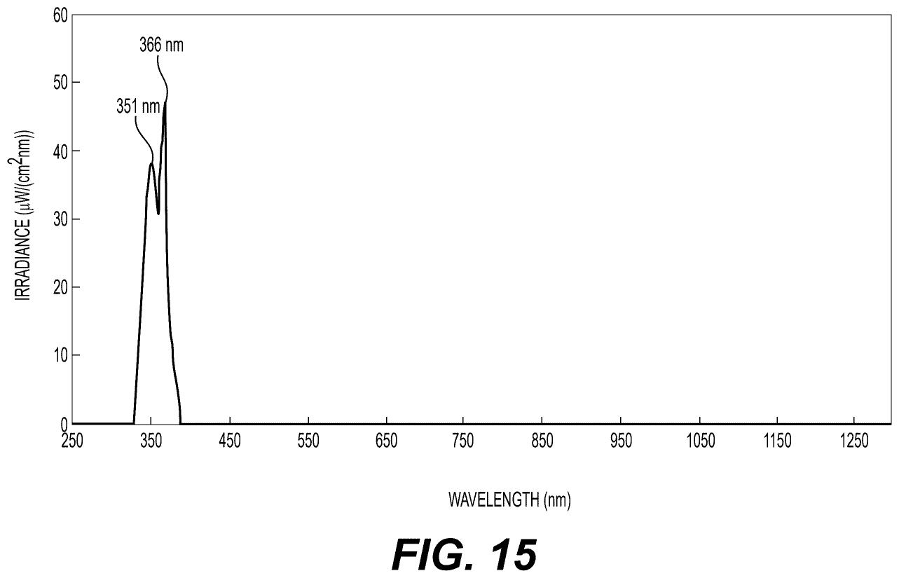

The Janus mesh was derived from the SA-ZnO-brass by exposing one face of the superhydrophobic mesh to three 6 W UV lights (manufactured by Sankyo Denki of Japan) for 24 hours. The distance between the lights and the mesh surface was 4 cm. The UV light source displayed peaks at 351 and 366 nm, as measured by an International Light Technologies™ ILT900-R spectroradiometer, as shown in FIG. 15. As the ZnO nanorods absorb wavelengths less than or equal to 364 nm (FIG. 2D), it was calculated that the absorbed incident UV radiation on the mesh was 909±72 μW/cm².

The fog harvesting rates of the fabricated meshes were measured from 5×5 cm² samples in the experimental setup. The fog was generated by an ultrasonic fog generator at a distance of 8 cm from the vertically suspended mesh. Deionized distilled water was fed to the fog generator to produce a fog flowrate of 0.22±0.04 L·h⁻¹ and a flow velocity of 1.86±0.25 m·s⁻¹. The temperature and relative humidity were kept at 22.8±0.5° C. and 87±4%, respectively. The amount of water collected during the fog harvesting was recorded by an electronic balance. The duration of one experimental run was five hours and three replicate runs were conducted to obtain a mean fog harvesting rate.

For investigating fog harvesting and water disinfection, the methylene blue (1-20 ppm) was purchased from Sigma-Aldrich® and was deliberately added to the water, which was then fed to the fog generator to produce MB-contaminated fog. During the experiment, three 6 W UV lamps were placed 10 cm away from the fog harvesting mesh, with surface UV irradiance kept at 214±14 μW·cm⁻². Water purification was observed over time (6-24 h), fog flowrate (0.08 to 0.22 L·h⁻¹), and MB concentration (1-20 ppm). The temperature and relative humidity were kept at 21.5±0.4° C. and 83±6%, respectively.

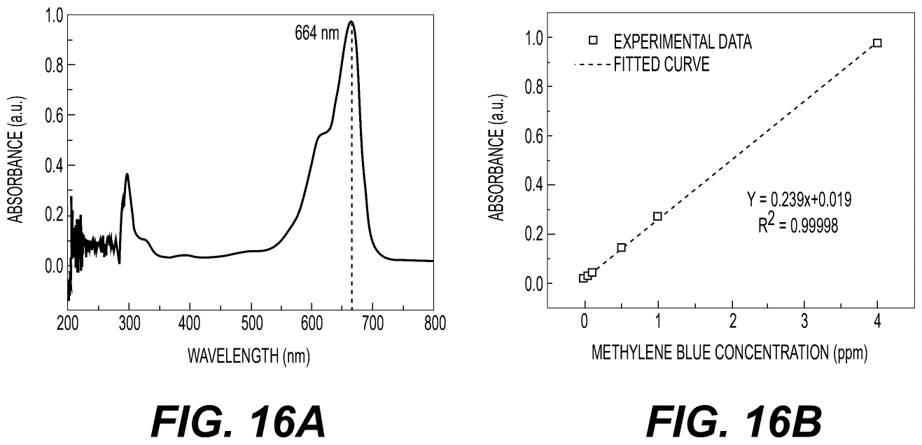

The water collected from the harvested fog was weighed every six hours (m) and MB concentration was determined using an Agilent® Cary 3500 UV-vis spectrometer (C). The MB concentration was determined from its absorption wavelength of 664 nm (FIG. 16A) using a set of standard calibration solutions (FIG. 16B). Four replicate runs were used to calculate the mean values and standard deviations of m and C. To determine the fog harvesting rate, m was divided by the surface area of the mesh and the water collection interval (i.e., 6 hours). The methylene blue removal efficiency η was calculated as

$$η = 1 - \frac{c}{{c}_{0}} .$$

To investigate the photocatalytic reaction mechanism of MB degradation, selective chemical scavengers for photogenerated holes (h⁺), hydroxyl radical (OH·), and superoxide radical (O₂·⁻) were added to the MB solution. These included potassium oxalate monohydrate (PO, ≥99.0%), tert-butanol (TBA, ≥99.0%), and 1,4-benzoquinone (BQ, ≥98%). The solutions were then fed to the fog generator to produce fog. A fog flowrate of 0.22±0.04 L·h⁻¹, corresponding to a flow velocity of 1.86±0.25 m·s⁻¹ was used. The MB concentration in the collected water was analyzed to determine its removal.

The Janus mesh's antibacterial property was assessed using ASTM E3160-18: Standard Test Method for Quantitative Evaluation of the Antibacterial Properties of Porous Antibacterial Treated Articles. Escherichia coli (ATCC 25922) was cultured in 5 mL of Oxoid nutrient broth no. 2 medium from Thermo Fisher Scientific® for 24 h at 37° C. and diluted in 9.9 mL of Oxoid phosphate buffered saline (PBS) from Thermo Fisher Scientific® to obtain a concentration of 105 CFU·mL⁻¹.

A 100 μL test inoculum was brought in contact with a 2×2 cm² Janus mesh and sandwiched between sterile glasses. After a 60 minute contact period, the sample was washed with 10 mL of the Remel Dey-Engley neutralizing broth from Thermo Fisher Scientific®, and the solution was recovered in a sterile container. After vortexing for 5 seconds, thrice, 100 μL of the neutralized solution was pipetted onto an Oxoid tryptone soya agar (Thermo Fisher Scientific®) plate and was spread using sterile glass beads. The plates were then incubated at 37° C. for 16 hours, and the colony forming units were enumerated. Triplicate samples were taken and measured.

Organic pollutants in the air can adsorb onto and foul the surface of water harvesting meshes, transforming hydrophilic surfaces into hydrophobic ones. In the experiment, the Janus mesh was used for continuous fog harvesting for 21 days in a laboratory setting at 21.8±0.5° C. and 68±8% relative humidity. The HL face of the Janus mesh was monitored, and the water droplet contact angle was measured every three days. A comparison was made against a superhydrophilic CuO-copper mesh prepared by heating a clean copper mesh in a Carbolite® CWF 11/13 muffle furnace at a rate of 25° C.·min⁻¹ to 500° C. and then keeping it at 500° C. for another two hours. Unlike photocatalytic ZnO nanorods, the CuO nanorods were inert as a photocatalyst. In a separate experiment, the Janus mesh was deliberately contaminated by immersing it in 0.2% (v/v) solution of oleic acid in ethanol, followed by drying for an hour at 40° C. The surface wettability was then characterized by measuring the water contact angle.

The contaminated Janus meshes were then regenerated by exposing the HL face to UV irradiation from three 6 W UV lamps with a wavelength of 352 nm and positioned 4 cm from the mesh. After the treatment process, the surface wettability was measured using water contact angle equipment to monitor the regeneration process. Water droplets with a volume of 7 μL were used for the contact angle measurements, and five replicates were conducted on different locations on the surface to obtain an averaged contact angle.

It is to be understood that the Janus mesh for fog harvesting and the method of making the same are not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A Janus mesh for fog harvesting, comprising a mesh having opposed first and second sides, the first side having a hydrophobic layer formed thereon and the second side having a hydrophilic layer formed thereon, the hydrophobic layer comprising ZnO nanowires and a hydrophobic coating, and the hydrophilic layer comprising the ZnO nanowires.

2. The Janus mesh for fog harvesting as recited in claim 1, wherein the mesh comprises a brass mesh.

3. The Janus mesh for fog harvesting as recited in claim 1, wherein the mesh comprises a brass-coated mesh.

4. The Janus mesh for fog harvesting as recited in claim 1, wherein the hydrophobic coating comprises stearic acid.

5. A method of making a Janus mesh, comprising:
growing ZnO nanowires on first and second sides of a mesh;
spraying the first side of the mesh with a hydrophobic coating to form a hydrophobic layer comprising the ZnO nanowires and the hydrophobic coating; and
treating the second side of the mesh with ultraviolet radiation to degrade any of the hydrophobic coating on the second side to form a hydrophilic layer comprising the ZnO nanowires.

6. The method of making a Janus mesh as recited in claim 5, wherein the mesh comprises a brass mesh.

7. The method of making a Janus mesh as recited in claim 5, wherein the mesh comprises a brass-coated mesh.

8. The method of making a Janus mesh as recited in claim 5, wherein the hydrophobic coating comprises stearic acid.

9. The method of making a Janus mesh as recited in claim 5, wherein the treating of the second side of the mesh with the ultraviolet radiation comprises exposing the second side of the mesh to the ultraviolet radiation for a sufficient time period to degrade the hydrophobic coating.

10. The method of making a Janus mesh as recited in claim 5, wherein the hydrophobic coating comprises stearic acid and the sufficient time period to degrade the hydrophobic coating is 24 hours.
